(19) United States
(12) Patent Application Publication
(10) Pub. No.: US 2011/0276365 A1
(43) Pub. Date: Nov. 10, 2011

(54) Computer assisted marketing process

(76) Inventor: Jeffery I. Siegel, Fort Worth, TX (US)

(21) Appl. No.: 12/800,157

(22) Filed: May 10, 2010

(51) Int. Cl. G06Q 10/00; G06F 15/16; G06F 21/00; G06Q 30/00

(52) U.S. Cl. 705/7.29; 705/14.45; 709/206; 726/3

(57) ABSTRACT

A system for contacting leads and tracking the status of those contacts includes a website containing information of interest to the prospects. Preferably, the list of leads is a narrowly targeted group defined by one or more preselected metrics, and the information is narrowly directed to such targeted group. Each lead is contacted through a secondary channel, such as normal US Mail, and provided an offer and information related to the website. Each lead is provided with targeted sales information and a unique identifier to enable them to log on to the website to retrieve information of interest to them; the act of logging on to the website then qualifies them as prospects. A tracking system recognizes when a prospect logs on to the website and keeps identifiable records of the time and locations each prospect visits or utilizes on the website. Upon receipt of a log on by a new prospect, a designated representative is informed of such contact by email and put in direct touch with the prospect. The salesperson further has a dashboard available for viewing the accumulated logs of the prospect's visits.

### BACKGROUND OF THE INVENTION

1. Field of the Invention

The present invention relates generally to computer and web based marketing systems, and more particularly to a system for enhancing the marketing of certain products.

2. Description of the Prior Art

Various techniques are used to determine and select preferred candidates to add to a master data base as leads for the marketing of various sophisticated products, such as financial products. The techniques currently used, such as direct mail, email blasts and print media give a relatively low response rate and do not further accurately qualify leads as prospects. Current systems often do not focus accurately on the potential clients having the greatest available income and needs to spend on the products of interest.

Further, communicating with the best potential clients can be problematic; most of these prospects would prefer to be able to learn about products without the perceived pressure of initially talking face to face with a provider or salesperson.

It would be desirable to provide an improved method and computer-based communications system that would enhance the identification of prospects and therefore the closing rate of sales made to viable prospects. This would also reduce overall marketing costs, customer acquisition costs and closing costs as well.

### SUMMARY OF THE INVENTION

In accordance with the present invention, a system for contacting leads and tracking the status of those contacts includes a website containing information of interest to the prospects. Preferably, the list of leads is a narrowly targeted group defined by one or more preselected metrics, and the information is narrowly directed to such targeted group. Each lead is contacted through a secondary channel, such as normal US Mail, and provided an offer and information related to the website. Each lead is provided targeted sales information and a unique identifier to enable them to log on to the website to retrieve information of interest to them; the act of logging on to the website then qualifies them as prospects. A tracking system recognizes when a prospect logs on to the website and keeps identifiable records of the time and locations each prospect visits or utilizes on the website. Upon receipt of a log on by a new prospect, a designated representative is informed of such contact by email and put in direct touch with the prospect. The salesperson further has a dashboard available for viewing the accumulated logs of the prospect's visits.

### BRIEF DESCRIPTION OF THE DRAWINGS

FIG. 1 is a block diagram illustrating the overall operation of a system in accordance with a preferred embodiment of the present invention;

FIG. 2 is a block diagram illustrating additional details of the system of FIG. 1;

FIG. 3 is a block diagram illustrating data flow through a preferred embodiment of the present invention; and

FIG. 4 is a flowchart of a preferred method for utilizing the system of the preferred embodiment in accordance with the present invention.

### DESCRIPTION OF THE PREFERRED EMBODIMENT

Those skilled in the art will recognize that the following description shows only a preferred embodiment of the present invention, and that numerous portions thereof can be implemented in an alternative manner. Therefore, the scope of the present invention is set forth in the appended claims, and is not limited to the illustrative embodiments described herein.

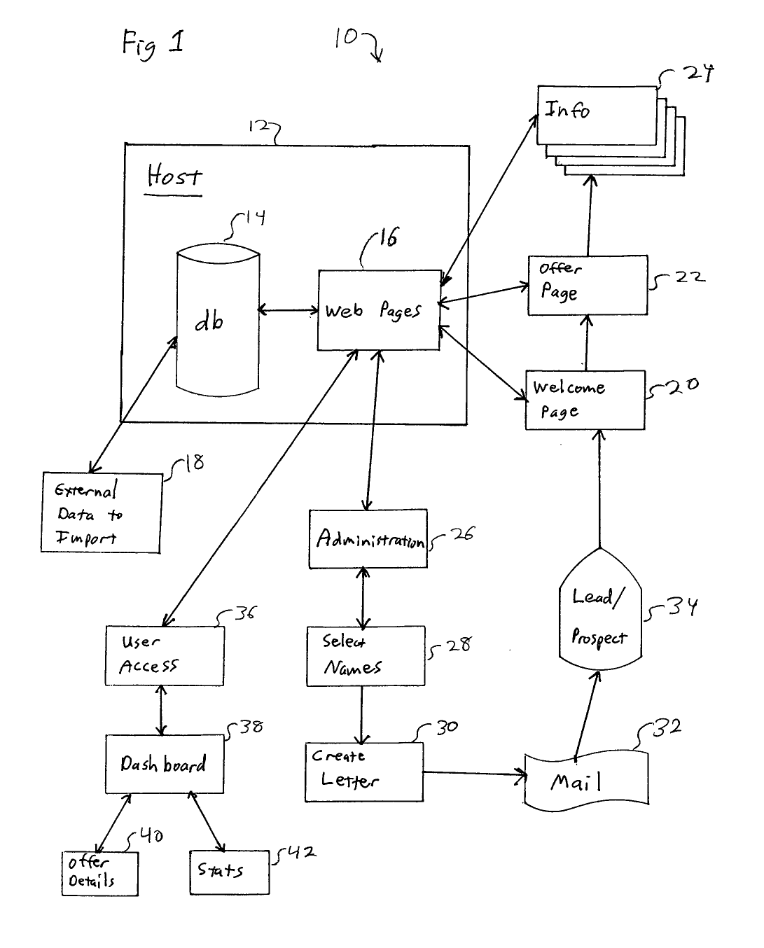

Referring to FIG. 1, a system for contacting and tracking prospects is designated generally with reference number 10. The system 10 operates on a host system 12, which in turn includes both a database 14 and a plurality of web pages 16 that define websites as described below. Database 14 maintains several types of information. This information includes basic data about people or organizational entities of interest, information obtained from interactions of such people with the web site pages, and information used to manage and operate the system as described herein. The database 14 and web pages 16 can be any suitable packages, such as Microsoft SQL Server and Microsoft IIS, for example.

As described below, initially data is collected regarding people or organizations of interest, and stored in database 14. Preferably, such data is made available externally in electronic form 18, and imported directly into database 14. This data should be checked and verified accurate to the extent possible. The entities defined by this data will be referred to herein as “leads” or “prospect,” depending on their current status. A lead is a person or organization that has been identified in the database 14. Mailings, as described below, may have been made to a lead. A prospect is a lead who has logged on to the website in response to receiving a notification as described herein. The difference between a prospect and a lead is that a lead has been identified as a potential customer, while a prospect has responded at least once to a contact. A notification is a direct mail letter or postcard that has been sent to a lead or prospect.

The web pages 16 include a welcome page 20 through which leads and prospects can log on to the website. Once a lead or prospect has logged on, they are sent to an offer page 22, and from there the prospect has access to various information pages 24. Once a lead has logged on to the welcome page 20 for the first time, the lead changes status and is considered a prospect.

Administrative web pages 26 are also made available on the website. Through these pages users and administrators can operate the system described herein. The primary function of the system is to send notifications to leads and prospects, and to provide a website for them to access. Also, all interactions between a prospect and the website are logged and analyzed, and used to drive future activity as described below.

A user is a person or organization who is trying to sell products or services to leads and prospects. A user is initially assigned to each lead before any notifications are sent to that lead, and each lead/prospect always has a corresponding user. A single user may have many leads. Within the administration portion of the system, leads/prospects are selected 28 to receive a mailing. Letters are created 30 to these leads/prospects, and these letters are personalized for the leads/prospects using data available in database 14. The corresponding user is also identified, and contact information for the user is provided. This creates a channel through which user/lead interaction is facilitated.

An offer is created and the notification letter is mailed 32 to the lead/prospect 34, preferably using US Mail. The lead/prospect 34 receives the notification, and hopefully finds the offer of value or is interested in other information contained in the letter. The major portion of the notification letter includes information particularly relevant to the leads/prospects based upon preselected criteria related to them. Information is provided in the letter telling the lead/prospect how to access the website 16, and providing an id and password to enable access. This enables the prospect to find and study further information of interest to them without having to contact a live representative, which is a step that causes many prospects not to follow up to advertising and other informational notifications of this type, such as direct mail campaigns, email with embedded url clicks and the like. Each lead/prospect 34 is assigned a unique identifier to enable website access, and no one is allowed access to the website without a valid identifier.

Each lead/prospect can contact website 16 over the Internet at a time of their own choosing. Such contact need not be made through a human representative. When the prospect logs on to the website 16, various tailored information can be dynamically generated to increase the value and appeal of the website 16 to the prospect. The content of website 16 is targeted to be of interest to the prospect as a result of the criteria used to generate the original lead list, and as a result of any prior visits to the website by the prospect.

If a prospect is interested in receiving further information after viewing the website, he or she may respond to the offer letter by various means such as telephone, email, fax or, preferably, they can enter information into website forms that indicates such interest. The entered information preferably includes contact information that can be used to put the corresponding user in touch with the prospect. This information is added to database 14, and is used to further automatically build out additional data on the prospect. In accordance with a preferred embodiment of the present invention, there is no personal contact with the prospect until such time as the prospect indicates that he or she desires such contact.

Users can access portions of the website through provided administrative pages 36. Users log on using unique identifiers and passwords, and have access to a personal dashboard 38. Through this dashboard, users can view and maintain information regarding their corresponding leads/prospects 40, and the system can be used to generate the notification letters described above. Also, detailed statistics are kept regarding the leads/prospects 42, and that information is made available to the users.

Whenever a prospect logs on to the website 16, every action taken by that prospect is logged. Each button or link that is clicked on is logged, along with a timestamp, so that the amount of time spent on each page is available. If the prospect enters any information into the system in response to a request, that information is also retained in database 14. The information about each prospect includes the original external data and a complete history of that prospect's interaction with the website. All of this information is made available to users through the statistics portion 42 of the administrative site.

An example of a field in which such system could be used would be with respect to financial services and products for mineral rights owners in a selected geographical region. Website content of particular interest to mineral rights owners can be generated, and stored into the database 14. These individuals may be a desirable market segment because they presumably have disposable income based on their mineral rights ownership, and many of them have questions, and legal and financial issues, relevant to their mineral rights. By providing a website specifically directed to issues of interest to mineral rights owners, sending pertinent information to these prospects can be seen as a useful service to them. When interested prospects log on to the website 16, the level of their interest can be gauged by tracking what portions of the site are visited and how much time is spent there.

A comprehensive program involves multiple contacts with each prospect over a period of time. Regularly generated marketing letters can be sent, each discussing an item of potential interest to the prospects and an offer specifically tailored to the users products or services. Each time a mailing is made to the selected prospects, a unique identifier is provided that allows them to access additional information on the website. Each time a prospect actually accesses the website, their actions there are tracked and stored in the database 14.

In addition, special mailings can be made to prospects who have previously responded to prior mailings by viewing the website. Even if these prospects to not request a personal contact by the corresponding user, their level of interest in the information on the website is confirmed by the fact that they made contact with the website. Repeat viewing of the website by a prospect indicates that that person feels that something of value is being offered and their status as a prospect is increased dramatically. For these returning prospects, additional mailings can be generated in order to increase their interest level and the likelihood that they will make contact with the corresponding user and a sales cycle or transaction will be initiated. And once the corresponding user has been contacted by a prospect that has shown previous interest in the subject matter, the probability of a sale of relevant products, such as financial instruments, to such prospect increases significantly.

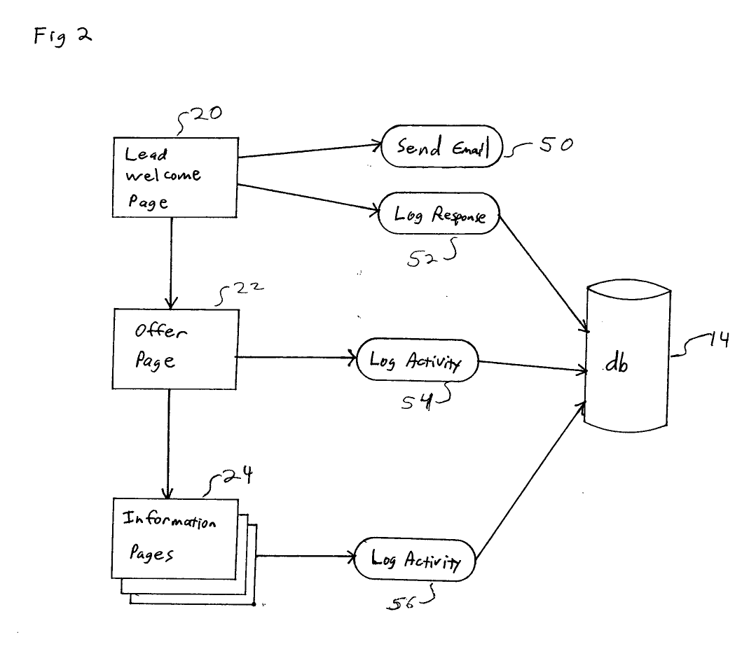

Referring to FIG. 2, additional details of the system are shown. The prospect makes contact through the internet with the welcome page 20. In existing systems such connections are generally anonymous, but since the prospect who is making contact is identified by the unique identifier provided in the notification sent to the prospect the identity of each person or organization who contacts the website is known. Access to the site is prevented unless the person accessing the welcome page 20 has a valid identifier, so once the prospect has provided this information, tracking their activity on the website is fairly straightforward.

Once the prospect has logged in, they are presented with an offer page 22 that corresponds to the mailing to which they are responding. Additional information 24 is made available on a series of web pages, and if this information is relevant and well presented the prospect will be encouraged to return and use the site as a reference resource. These pages are custom tailored to each prospect using dynamic web page generation techniques as known in the art. Use of Active Server Pages, or similar dynamic page generation techniques as known in the art allows such customized generation of web pages.

The information used to generate the web pages is provided by the database 14, and preferably includes static information that is the same for each prospect. Also included are fields that can be populated in response to information previously known or collected about the prospect. For example, if a prospect has previously indicated that they have small children, pages of interest can be provided that relate to persons having small children, whereas these pages may not be relevant to retired persons. Once a prospect has accessed the website and created a session, when they return in the future additional information can be made available to them based upon the nature and extent of interest they have shown in the past, whether they have contacted a designated representative, or other session factors. Whenever a prospect contacts the website, tracking utilities record each page visited, each button clicked on, and how long each page was visited.

When a prospect logs on to the site, an email is sent 50 to the corresponding user to advise them of this fact. The logon is logged and time stamped 52, and stored in database 14. All activity on the offer page 54 and any other pages accesses by the prospect 56 is also logged in the database. This enables the corresponding user to be completely up to date regarding the status of inquiries by the prospect, so that any follow up can be performed with an understanding of what the prospect is interested in, as indicated by their viewing of the website.

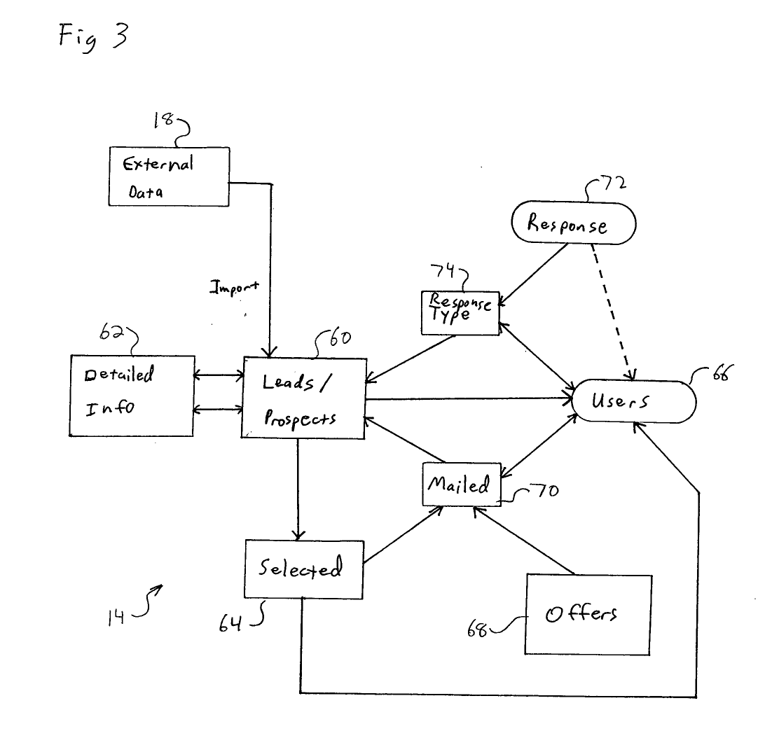

FIG. 3 is a high level diagram of the data maintained in database 14, and the flow of data as the process unfolds. As described previously, external data is imported into database 14, and stored in one or more tables 60 containing information relating to leads and prospects. As known in the art, this data can be located in multiple tables within the database 14, as is represented by the detailed information block 62 connected to leads table 60. Some of the information in these tables is provided by the original import of external data, while other data is generated during the course of running the system. Also, additional external can be added at any time that it becomes available.

When a mailing to leads/prospects is desired, selected leads/prospects 64 are provided to the users 66. Depending on the implementation details, the users 66 may handle the actual mailing of the notification letters, or this can be automatically done for them. Preferably, personalized form letters are generated for the users, who add a personal touch and handle the actual, physical mailing of the notification letters.

A separate portion of the database contains the detailed offers 68 to be placed into the notification letters. The decision of which offers are to be mailed, and when, is preferably handled by a central authority, but in some cases input from users 66 may be desirable. The offer information 68 is combined with the selected leads/prospects information 64 to generate the mailings 70. Only when the notification letters are actually sent, and this fact noted by the users 66 or other entity tasked with handling the physical correspondence, are the letters considered to be “mailed” 70.

In response to some portion of the mailings, responses 72 are generated by prospects. (Once a response is generated, a lead is considered to be a prospect.) Preferably, most prospects respond by logging on to the website as described above, in which case a response type 74 is collected, and details of the visit as well, as previously described. However, in some cases a prospect may contact the user 66 directly, by telephone, email, written physical correspondence, or other means. These responses are considered to be responses similar in result to logging on to the website; in either case the lead has become a prospect by responding to one of the mailings sent to him. If a user 66 receives a direct response in this manner, that user 66 enters such fact into the system and the type of response becomes part of the database of information on that prospect.

Users 66 thus provide input into the system by mailing notification letters, and by entering information related to their contacts with prospects. Once a contact has been made, the user performs normal sales activity with the prospect, ideally resulting in one or more sales to that prospect over, perhaps, a period of years. Once the initial relationship has been established between the users and prospects, that relationship grows beyond the tracking requirements and abilities of the present system. However, the present system can supplement future contacts in that relationship by continuing to send notifications out to the prospects, and can provide an additional avenue of communication beyond that generated by the normal user/prospect relationship.

Users are able to keep up with the status of their assigned leads through reports generated by the system. In addition, as described above, emails are preferably sent to the users whenever a prospect logs on to the website for information. Users are able to access all of the information available for the leads/prospects to which they are assigned, but not those of other users. Of course, higher level management will be able to access all information that they need to be able to access. Thus, for example, a branch manager can be given access to all data for salesmen working out of that branch, etc.

Preferably, each user will be able to log on to the system and be presented with a dashboard that presents information of interest that is available to that user. This will enable users to run reports and analysis that will aid them in their sales efforts. Also, at a higher level analysis of data will help managers determine when notification letters should be mailed, and which types of offer letters are to be sent to which types of prospects. Preferably, some of the data analysis is through pre-written routines that select useful data and present it in an informative manner; this is particularly useful for the typical user. Also, unlimited database queries are made available, in particular to management and system decision makers, for the purpose of data mining, trend spotting, and ad hoc analysis.

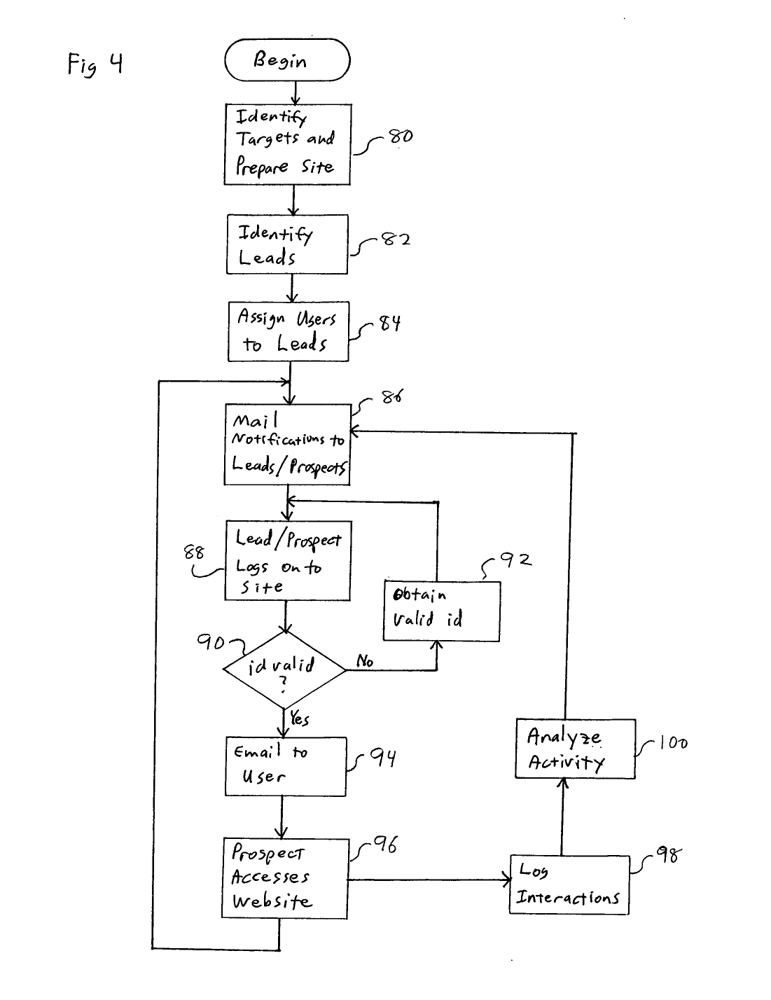

FIG. 4 is a high level flowchart outlining the steps undertaken when implementing the process as described above. First, a topic of interest is identified and a website containing information of interest to a targeted group is prepared 80. Next, a set of leads is identified 82. Selection of the leads is important to the success of the process described herein; by selecting a factor, or set of factors, that defines a set of leads having the desired characteristics, a well targeted sales program can be prepared for them. The better the match between the characteristics of the leads and the products or services being sold, the higher will be the response rate of the system.

Prior to any contact, a user is assigned to each lead 84. This enables the creation of customized marketing pieces for both the leads/prospects and users and relationally ties all concerned together with the data generated during website sessions. This user will preferably be identified on each customized mailing sent to each lead/prospect, and will be available at any time to answer questions or assist the prospect with any problems they may have regarding the website or the products being made available. The user also will have expertise concerning the products and services being sold, and may be able to answer other questions not directly related to the information provided on the website. In the preferred embodiment, the designated representative does not contact the prospect until the prospect has indicated that he or she desires such contact. This leaves the prospects in control of their individual information flow, and maintains the feeling for each prospect that they are in charge of events and not being pressured to “buy something” or ‘hard sold”.

A notification letter is then sent to each prospect 86. This letter contains the terms of an offer, or information that is relevant to the prospect as determined from the information available about them. The notification letter preferably sent through standard mail, but other techniques can be used. However, the notification technique preferably is personal, and does not use mass mailing techniques, such as email, which generate a low response rate. Also, intrusive techniques such as cold telephone calling are not preferred, as the point of the system is to allow the prospect to determine the pacing and timing by which information is obtained and action is taken. This approach has been shown to result in a better response and closure rate than higher pressure, more direct techniques.

The interested lead/prospect then logs on to the web site 88 using the identifier supplied in the notification letter. A check is made 90 to determine whether the identifier is valid. If not, or the prospect tries to directly access a portion of the site other than the log on portal, they will be directed to a page that requires them to log on using a valid identifier 92. This not only prevents outsiders from accessing the information on the site, but enables the tracking of each prospect's activity while logged on. If a prospect is unable to successfully log on, they may contact their corresponding user, whose contact information is provided in the notification letter, to obtain a valid access code.

This two part use of unique log on identifiers provides multiple benefits for those running the system. Because every prospect is able to be tracked using their unique identifier, products and services can be more specifically targeted to their needs in the future. Mailings of future notification letters (offers) can be targeted, so that prospects receive information of more use to them, and so that less effort is wasted providing this information. Further, the prospect's interaction with the website can be personalized based upon information previously saved, so that, for example, a column of buttons linking to items of interest can be dynamically generated in an order tailored to that prospect. Thus, for example, a prospect who has previously shown interest in life insurance products could be presented with a selection having these types of products displayed at the top, or otherwise prominently; on the other hand, a prospect who has shown interest primarily in real estate investments will be presented with a selection list having a different order, or even a different selection entirely.

The use of unique identifiers serves to eliminate many people from gaining access to the system. In addition to security concerns, an important goal of the system is to improve the ratio of prospects who are likely to buy from those who are not. Because the website and notifications are tailored to leads and prospects having particular characteristics, it is counterproductive generally to expend effort on those not having these characteristics. By excluding these entities form website access, the focus remains narrow and the likelihood of success increases noticeably.

Once a valid identifier is provided, an email is sent 94 to the corresponding user. The prospect is allowed access to the dynamically generated site 96. All interactions of interest with the site are logged 98 in the database. At any convenient time, reports of that prospect's access are automatically prepared by the system using analytical tools 100, as can reports containing aggregated information across all prospects or subsets of prospects.

After prospects access the web site, whether only once or on multiple occasions, the process returns to step 86 and they will be mailed another letter in the future. Which notification letter is mailed to the prospects, and the timing and contents of that letter, may be modified based upon the activity analysis 100 for that prospect. Thus, for example, a prospect who evidences interest in life insurance may receive a different set of mailings than one interested in purchasing a new car. As described previously, this information is made available to the user through the dashboard, and if desired the user can be allowed to modify the timing and identity of future notification letters sent to that user's prospects.

In practice, most prospects who are going to access the web site in response to a mailing will do so within a relatively short time after the notification is received; a few days to a week or two is typical. Responses can be further enhanced by a simple cost effective plain post card with a message containing the unique identifier, printed by a variable printing service Most of the time, several contacts and an interesting offer are required to catch a prospect's interest, which is in part a function of familiarity with the notifications and in part a function of random factors.

Anyone that has a meaningful database could use the system described herein to mine for unique offers and point products at leads. Companies using direct mail could use the system to further generate interest in products. Companies that rely on longer sales cycles, or provide complex or expensive products and concepts, will benefit more than those selling products normally purchased by impulse. Examples might include a medical device company marketing to specialist doctors with field sales support. In this case it could be developed further to include invitations to lunch and learn and view medical procedures at their desk and the company pays for lunch.

As will be appreciated by those skilled in the art, the system and method described herein provides a tool that greatly assists in identifying likely prospects for certain types of sales. In the case of individualized and expensive products, such as various insurance and investment products, increasing the number of properly targeting prospects will result in an improved rate of closing sales. The system described herein presents valuable information to identified potential prospects (leads), and spends most of its effort tracking and consolidating information received from those persons and organizations who have actually shown some interest in the products or services being offered. This means that more effort is expended on those prospects who are the most likely to become a purchaser, resulting in a higher response rate that is typical, made at a lower acquisition cost per valid prospect than is ordinarily experienced.

While the present system and method does not directly aid in closing sales, it does help by providing useful information leading up to the opportunity to close, and improves the overall closure rate by improving the ratio of good prospects to overall leads. In cases where sales are driven by the difficulty of identifying good prospects in the first place, use of the indirect feedback techniques described herein can substantially increase the rate at which sales are closed, while providing a useful service to the prospects.

Variations in the technology used to implement the method and system described above will become apparent to those skilled in the art. For example, cookies can be used to aid in tracking activities on the website by prospects. However, in the preferred embodiment cookies are not used instead of having the prospects log in for each visit because cookies can change outside of the control of the system, are not always available if the prospect has multiple computers, and cookies do not perform the filtering and security function that unique identifiers do. Thus, use of cookies, if done at all, is preferably supplemental to the use of unique identifiers, and will generally be limited to helping track individual log on sessions.

Also, if desired, a new unique identifier can be used with each notification letter. In this manner, each prospect will use a different identifier each time they log on in response to a particular notification letter. The system can either accept previous identifiers or reject them with instructions to the prospect to obtain a new identifier. In cases where prospects receive a new identifier in each notification letter, the system is able to track which letter prompted the response, which is an important data point in itself. If desired, once a prospect logs on to the website for the first time, he or she can select or be assigned a permanent identifier that can be re-used for future visits. In general, the idea is to get prospects to log on, and multiple visits are better than a single visit. Thus, the requirement for unique identifiers should be as unobtrusive as possible consistent with the security and identification issues described herein.

It will be appreciated by those skilled in the art that the invention described above, in its several alternative embodiments, may be modified in various ways within the scope of the invention.

What is claimed is:

1. A method for tracking potential purchasers of a product or service, comprising the steps of:
providing a notification that includes a unique identifier to each identified one of a selected group of potential purchasers, wherein the unique identifier allows access to a website;
when a potential purchaser logs on to the website using their unique identifier, presenting a version of the website tailored to that particular potential purchaser;
maintaining a log of all interactions between each logged on potential purchaser and the website, wherein such log maintains a correspondence between the logged actions and the potential purchaser;
generating a follow up notification to the potential purchasers that includes, in part, elements that are determined as a result of prior interactions with the website for those potential purchasers who logged on using their unique identifier; and
repeating the steps of presenting, maintaining, and generating.

2. The method of claim one, wherein the step of generating a follow up notification includes providing a new unique identifier with the follow up notification.

3. The method of claim 1, further comprising the steps of:
creating a report analyzing the log of interactions with the website; and
displaying the report on a dashboard.

4. The method of claim 1, further comprising the step of:
for each of the potential purchasers, prior to providing such potential purchaser a first notification, assigning a user to such potential purchaser and including identifying information regarding such user in the notification.

5. The method of claim 4, further comprising the step of:
when a potential purchaser logs on to the website, sending and email notification to the assigned user identifying the particular potential user who logged on.

6. The method of claim 1, further comprising the steps of:
if a potential purchaser attempts to log on to the website without a valid unique identifier, preventing such potential purchaser from logging on; and
directing the potential purchaser to a location from which a valid unique identifier can be obtained.

7. A system for tracking potential purchasers of a product or service, comprising:
a central system having a database and a website, wherein the website includes a portal page to allow only entities having a preselected unique identifier to log on to the website, and wherein the database includes information related to a plurality of preselected leads;
a connection for the website to the Internet, wherein a person having a preselected unique identifier can log on to the website over the Internet;
an administration module, wherein selected ones of the plurality of preselected leads can be selected to receive a notification letter that includes one of the preselected unique identifiers;
means for transmitting the notification letter to the preselected leads;
tracking means for logging all activity on the website caused by preselected leads who log on to the website; and
an interface that is adapted to generate reports regarding the activity on the website caused by preselected leads who log on.

8. The system of claim 7, wherein the website further includes an offer page containing information related to the notification letter, and a plurality of additional pages containing information relevant to the preselected leads.

9. The system of claim 8, wherein the plurality of additional pages is generated dynamically in response to the unique identifier used to log on to the website, whereby potential purchaser are able to view web pages targeted to them.

10. The system of claim 7, wherein the tracking means comprises at least one log file generated when the potential purchasers access the website.

11. The system of claim 7, further comprising an email interface for sending an email to a user assigned to a particular potential purchaser whenever that particular purchaser logs on to the website.
